(19) United States
(12) Patent Application Publication
(10) Pub. No.: US 2026/0274070 A1
(43) Pub. Date: Sep. 17, 2026

(54) PROCESSING METHOD AND VEHICLE

(71) Applicant: Lenovo (Beijing) Limited, Beijing (CN)

(72) Inventors: Dongyuan CHEN, Beijing (CN); Bingchuan SUN, Beijing (CN); Lu CAO, Beijing (CN)

(21) Appl. No.: 19/307,821

(22) Filed: Aug. 22, 2025

(30) Foreign Application Priority Data
Aug. 30, 2024 (CN) 202411214917.1

(51) Int. Cl. B60K 35/28; B60K 35/23; G06T 7/11; G06V 20/58

(52) U.S. Cl. CPC B60K 35/28; B60K 35/23; G06T 7/11; G06V 20/58; G06V 2201/07

(57) ABSTRACT

The present disclosure provides a processing method, including: obtaining a tap position of a target user on a target vehicle window, the target vehicle window being capable of displaying an image; determining an initial landing position, in an outside-vehicle scene, for a line connecting the tap position and a head target position of the target user; when the initial landing position is a far-view landing position, determining a target near-view point that satisfies a predefined positional relationship with the initial landing position; determining a target object from the outside-vehicle scene based on the target near-view point; and displaying target information of the target object on the target vehicle window.

### CROSS-REFERENCE TO RELATED APPLICATION

This application claims priority to Chinese Patent Application No. 202411214917.1, filed on Aug. 30, 2024, the content of which is incorporated herein by reference in its entirety.

### TECHNICAL FIELD

The application relates to the technical field of transparent display, and in particular to a processing method and a vehicle.

### BACKGROUND

As emerging display equipment, transparent display offers a wide range of applications within transparent vehicle windows. One potential application involves passengers tapping an external object with their finger, which then returns information about the corresponding object. However, in this scenario, when a user taps an external object through the vehicle window, their line of sight is focused on the object, making it impossible to clearly see the position of the tap on the window. Consequently, the tap position cannot be accurately positioned to the external target object.

### SUMMARY

In one aspect, the present disclosure provides a control method, including: obtaining a tap position of a target user on a target vehicle window, the target vehicle window being capable of displaying an image; determining an initial landing position, in an outside-vehicle scene, for a line connecting the tap position and a head target position of the target user; when the initial landing position is a far-view landing position, determining a target near-view point that satisfies a predefined positional relationship with the initial landing position; determining a target object from the outside-vehicle scene based on the target near-view point; and displaying target information of the target object on the target vehicle window.

In another aspect, the present disclosure provides a vehicle, including a vehicle body; a target vehicle window, capable of displaying an image and having a touch layer, and capable of acquiring a tap position on the target vehicle window; a target acquisition device, configured to acquire a head target position of a target user; and a processing device, including a memory and one or more processors, where the memory stores a computer program executable by the one or more processors, and when executing the computer program, the one or more processor are configured to perform: obtaining the tap position of the target user on the target vehicle window, determining an initial landing position, in an outside-vehicle scene, for a line connecting the tap position and the head target position of the target user, when the initial landing position is a far-view landing position, determining a target near-view point that satisfies a predefined positional relationship with the initial landing position, determining a target object from the outside-vehicle scene based on the target near-view point, and displaying target information of the target object on the target vehicle window.

It is to be noted that the above general description and the following detailed description are merely exemplary and explanatory, and are not intended to limit the technical solutions of the present disclosure.

### BRIEF DESCRIPTION OF THE DRAWINGS

In order to more clearly illustrate the technical solutions in the embodiments of the disclosure, the drawings essential for understanding the disclosed embodiments will be briefly described below. Apparently, the drawings described below are merely some embodiments of the disclosure. For a person skilled in the art, other drawings may be obtained based on the provided drawings without making creative efforts.

FIG. 1 is a flow chart of a processing method, according to an embodiment of the disclosure.

FIG. 2 is a schematic diagram of another processing method, according to an embodiment of the disclosure.

FIG. 3 is a schematic diagram of obtaining a target close-up object through a processing method, according to an embodiment of the present disclosure.

FIG. 4 is a schematic diagram of an image segmentation effect, according to an embodiment of the present disclosure.

FIG. 5 is a schematic structural diagram of a processing device, according to an embodiment of the present disclosure.

### DETAILED DESCRIPTION

Various aspects and features of the present disclosure are described herein with reference to the accompanying drawings. It is to be noted that various modifications may be made to the embodiments of the present disclosure. Therefore, the following description should not be considered as limiting, but merely as examples of embodiments. Other modifications within the scope and spirit of the present disclosure will become apparent to those skilled in the art.

The accompanying drawings, which are incorporated in and constitute a part of the disclosure, illustrate embodiments of the present disclosure and, together with the summary of the specification given above and the detailed description of the embodiments given below, serve to explain the principles of the present disclosure.

These and other characteristics of the present disclosure will become apparent from the following description of some specific embodiments provided as non-limiting examples with reference to the accompanying drawings.

It is to be noted that although the present disclosure has been described with reference to some specific embodiments, those skilled in the art will readily be able to implement many other equivalent forms of the present disclosure.

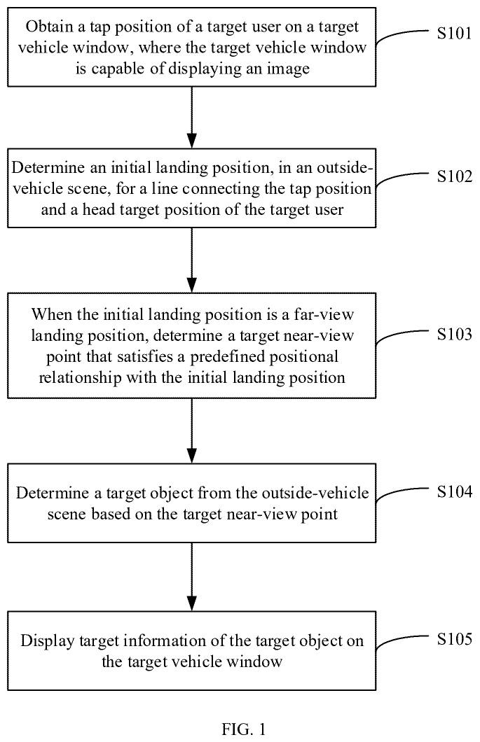

According to at least one embodiment of the present disclosure, a processing method is provided. As shown in FIG. 1, the processing method may include the following steps.
S101: Obtain a tap position of a target user on a target vehicle window, where the target vehicle window is capable of displaying an image.
S102: Determine an initial landing position, in an outside-vehicle scene, for a line connecting the tap position and a head target position of the target user.
S103: When the initial landing position is a far-view landing position, determine a target near-view point that satisfies a predefined positional relationship with the initial landing position.
S104: Determine a target object from the outside-vehicle scene based on the target near-view point.
S105: Display target information of the target object on the target vehicle window.

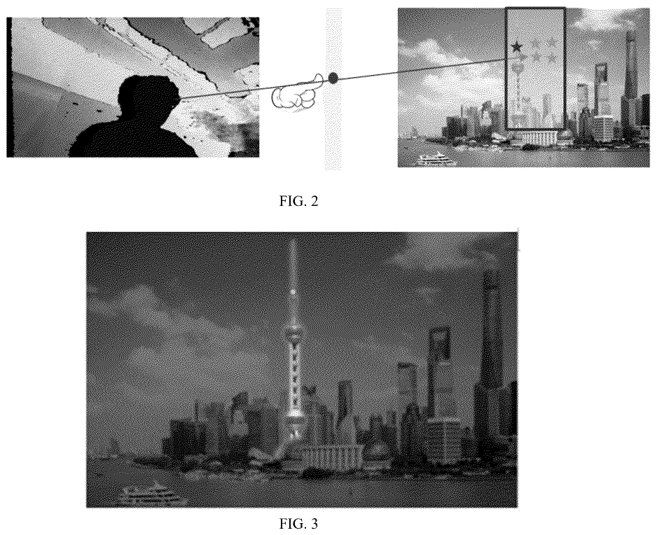

For ease of understanding, the processing method will be described below using the application of the method to a vehicle. The vehicle has a transparent target vehicle window, allowing a user to see the scene outside the vehicle through the target vehicle window. The above steps are specifically described with reference to the schematic diagram shown in FIG. 2.

For step S101, assuming that the outside-vehicle scene may include the blue sky, white clouds, the oriental pearl TV tower, the Huangpu river and other buildings, in the above step S101, the target user is located on the interior side of the vehicle window. When the target user attempts to tap on the target vehicle window for an object outside the window using his finger, a tap operation is performed to generate a tap position.

In the above step S102, first, a head target position between the binocular eyes of the target user is obtained. Then, based on the head target position and the tap position obtained in the above step S101, a straight line may be determined, which forms an intersection with the scene outside the car window. The intersection point is then determined as the initial landing position. Here, the head target position may be one of the center of eyebrows, the left eye, or the right eye. For example, the initial landing position in FIG. 2 is a certain position in the blue sky, and the initial landing position is recorded as position A. It is to be noted that the position A elsewhere in the disclosure refers to a same thing (i.e., the initial landing position). Through a vehicle-mounted sensing device, a three-dimensional scene coordinate system may be established, so that the external scene and the objects inside the car and windows are in a same three-dimensional scene coordinate system, so that the initial landing position is calculated through the three-dimensional scene coordinate system.

For step S103, the near view and the far view are first defined as follows. An object in the scene outside the window that is relatively close to the car window is a near-view object, and an object in the scene outside the window that is relatively far from the car window is a far-view object. In the above step S103, it is determined whether the initial landing position is a far-view landing position. If the initial landing position is a far-view landing position, a target near-view point that satisfies a predefined positional relationship with the initial landing position is determined. The initial landing position in FIG. 3 is a position in the blue sky, namely position A. Since there are other buildings, such as the oriental pearl TV tower in the scene outside the window, that are closer to the target user than the blue sky, the initial landing position (e.g., position A) is a far-view landing position. Since the purpose of the user's tap behavior is to select a target object in the near view, e.g., the oriental pearl TV tower in the near view, it is necessary to determine a target near-view point that satisfies a predefined positional relationship with the initial landing position (e.g., position A), such as the points marked by several five-pointed stars shown in FIG. 2.

In step S104, based on the target near-view point determined in step S103, the target object to which the target near-view point belongs may be determined. For example, the target near-view point of the initial landing position (e.g., position A) may be within the oriental pearl TV tower. Therefore, based on the target near-view point, the target object may be determined to be the oriental pearl TV tower.

In the above step S105, the target information of the oriental pearl TV tower (i.e., the target object determined in the above step S104) is displayed on the vehicle window.

The processing method provided in the disclosure first determines the initial landing position through the head target position and the tap position. When the initial landing position is not in the target near-view area, the method determines the target near-view point through the initial landing position, and then determines the target object in the target near-view area. This effectively solves the problem of inaccurate taps on the target object due to user parallax and improves the accuracy of user selection of the target object when using a transparent display device.

In some embodiments, in the above step S103, the method of determining the initial landing position as the far-view landing position may include: obtaining a two-dimensional image corresponding to the outside-vehicle scene; determining the near-view area and the far-view area of the two-dimensional image; mapping the initial landing position into the two-dimensional image to obtain a mapping position; when the mapping position is in the far-view area, determining the landing position as the far-view landing position.

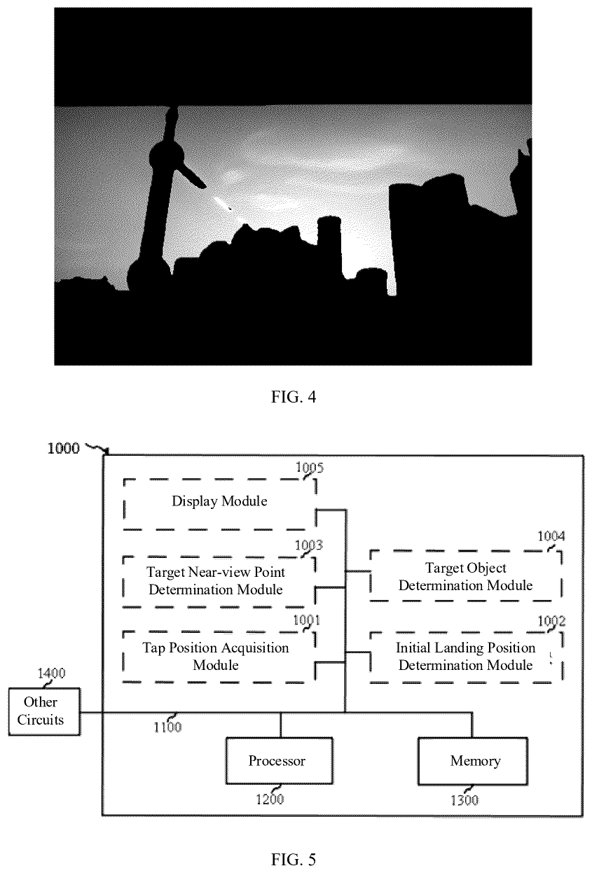

For ease of understanding, the processing method will be described by applying the method to a vehicle. First, an image outside the vehicle window is acquired. The image is a two-dimensional image, which may be acquired by an image acquisition device, such as a camera. Second, the near view and far view in the two-dimensional image are determined. Specifically, the near-view area and far-view area of the two-dimensional image may be obtained by an image segmentation method. FIG. 4 shows the effect of image segmentation on the two-dimensional image of an outside-vehicle scene. As can be seen from FIG. 4, various buildings, including the oriental pearl TV tower, are segmented into one area, namely, the near-view area with a smaller grayscale value, and objects such as the blue sky and white clouds are segmented into another area, namely, the far-view area with a larger grayscale value. Then, the initial landing position (e.g., position A) obtained in the above step S102 is mapped into the two-dimensional image to obtain the mapping position of the initial landing position in the two-dimensional image. Thereafter, the location for the mapping position is determined in the two-dimensional image, that is, whether the location of the mapping position is in the far-view area or the near-view area. Since the near-view area and far-view area of the two-dimensional image have been obtained through image segmentation, the area to which position A belongs may be determined by the mapping position of position A in the two-dimensional image. If the location of the mapping position is in the far-view area, the initial landing position is determined as the far-view landing position. In the above, the image segmentation may be performed through semantic segmentation using a deep learning algorithm, such as the segment anything model (SAM). After image segmentation, the far-view area and near-view area of the two-dimensional image are obtained.

The present disclosure may map the initial landing position in the two-dimensional image, and use the mapping position in the two-dimensional image to determine whether the initial landing position is a far-view or near-view landing position, and then further approach the desired near-view object in subsequent processing to facilitate user taps and selections, which helps to improve the user's tap accuracy on the target object.

In some embodiments, in the above step S103, the method of determining the initial landing position as the far-view landing position may also include: determining a target value of the initial landing position in a first dimension, where the first dimension matches the normal direction of the target vehicle window, and a coordinate axis of the first dimension in the three-dimensional coordinate system extends in a direction away from the target vehicle window; when the target value is greater than a specific threshold, determining the initial landing position as the far-view landing position.

For ease of understanding, the processing method is continuously explained by applying it to a vehicle. First, the straight line formed between the head target position and the tap position passes through the target vehicle window. The initial landing position (e.g., position A) forms a corresponding coordinate value in the normal direction of the target vehicle window, which is used as the target value. Then, a specific threshold is predefined, and the relationship between the target value and this threshold is determined. If the target value is greater than this threshold, position A is determined as the far-view landing position. Otherwise, position A is determined as the near-view landing position.

The present disclosure solves the problem of determining whether the initial landing position is a near view or a far view by comparing a predefined threshold with a target value of the initial landing position in the first dimension to determine whether the initial landing position is a near view or a far view.

In some embodiments, in the above step S103, determining a target near-view point that satisfies a predefined positional relationship with the initial landing position includes: searching along a first direction and a second direction to determine multiple first points that satisfy the predefined positional relationship with the initial landing position, where the first points are all landing points in the external scene on a line connecting the head target position of the target user and a point on the target car window; and determining a near-view point among the plurality of first points as the target near-view point.

To facilitate understanding, the following example is further provided for illustrative purposes. Since the initial landing position isn't necessarily the user's desired near-view landing position, further approximation to the desired near-view of the user tap based on the initial landing position is necessary. From the user's perspective relative to the vehicle window, the desired near-view landing position may be in several directions relative to the initial landing position. For example, if the first and second directions are to the left and right of the initial landing position (e.g., position A), first, a predefined range of positions is determined from the left and right directions of the initial landing position. Points falling within the predefined range are identified as first points. There may be multiple first points. Next, a determination is made as to whether a first point of the multiple first points is a near-view point. If the first point is a near-view point, the first point is identified as the target near-view point. It is to be noted that the first and second directions may also be upward or downward. At this point, the corresponding method for determining a target near-view point is similar to the above-described method and will not be further described here.

The present disclosure searches for near-view points within a predefined positional range along different directions from the initial landing position, and then determines a near-view target object based on the near-view points, thereby assisting the user in improving click accuracy and solving the problem of inaccurate taps of the initial landing position caused by parallax.

In some embodiments, satisfying the predefined positional relationship includes that a distance corresponding to the initial landing position is less than a distance threshold, and the method further includes: obtaining a target distance between the head target position of the target user and the target vehicle window; and determining the distance threshold based on the target distance.

For ease of understanding, the application of the disclosed processing method to a vehicle is further explained as an example, which includes two cases. The first case: First, obtain a target distance between the head target position of the target user and the target vehicle window; then, map the initial landing position in the two-dimensional image to obtain the mapping position of the initial landing position in the two-dimensional image, and determine a distance threshold of the mapping position in the two-dimensional image based on the target distance. The second case: First, obtain a target distance between the head target position of the target user and the target vehicle window; then, map the initial landing position in the 3D space, and determine the distance threshold of the mapping position in the two-dimensional image based on the target distance.

In some embodiments, the larger the target distance, the smaller the distance threshold. Specifically, since a user's line of sight is focused on an object in the external scene, the finger tapping on the car window will be perceived as two separate fingers in the user's field of view; that is, the finger's double image will be perceived. At this time, the larger the target distance, the farther the user is from the car window, and the smaller the distance between the two separated fingers perceived by the user, that is, the smaller the impact on the user's inaccurate tap. Therefore, the distance threshold may be reduced to mitigate the problem of matching a non-target object caused by an excessively large distance threshold.

In some embodiments, determining the target near-view point that satisfies the predefined positional relationship with the initial landing position includes: determining a mapping position corresponding to the initial landing position in a two-dimensional image, where the two-dimensional image is an image corresponding to an outside-vehicle scene, and the two-dimensional image is segmented into a near-view area and a far-view area; and determining the target near-view point from the two-dimensional image according to the mapping position, where a distance between the target near-view point and the mapping position is less than a distance threshold.

Exemplarily, the description will continue with reference to FIG. 2. When the initial landing position is determined, the mapping position corresponding to the initial landing position (e.g., position A) in the two-dimensional image is determined. At the same time, a distance threshold is predefined, and a point whose distance from the mapping position is less than the distance threshold is determined as the target near-view point.

In some embodiments, determining the target near-view point that satisfies a predefined positional relationship with the initial landing position includes: determining a target near-view point from an outside-vehicle scene, where a distance between the target near-view point and the initial landing position in a second dimension is less than the distance threshold, and the second dimension matches a cross-section of the target vehicle window.

As an example, a cross-section of the target vehicle window is used as the second dimension. Based on the second dimension, the distance between the target near-view point and the initial landing position (e.g., position A) is calculated. If the calculated distance is less than a predefined distance threshold, the target near-view point is determined to be the position of the target object.

In some embodiments, determining the target object from the outside-vehicle scene based on the target near-view point may include: inputting a two-dimensional image corresponding to the target near-view point and the outside-vehicle scene into a target model; receiving a target segmented image corresponding to an individual object segmented from the two-dimensional image by the target model based on the target near-view point; and determining the target object based on the target segmented image.

In some embodiments, determining the target object from the outside-vehicle scene based on the target near-view point may also include: obtaining a two-dimensional image corresponding to the outside-vehicle scene, the two-dimensional image being segmented into multiple segmented images corresponding to individual objects; determining a target segmented image from the multiple segmented images based on the target near-view point; and determining the target object based on the target segmented image.

For ease of understanding, the following example is used for illustrative purposes. First, a two-dimensional image corresponding to the outside-vehicle scene is obtained, and the two-dimensional image is segmented using an image segmentation method. After segmentation, segmented images of several individual objects may be obtained. For example, when the two-dimensional image in FIG. 2 contains multiple objects such as blue sky, white clouds, the oriental pearl TV tower, the Huangpu river, and other buildings, the multiple segmented images after image segmentation respectively include the blue sky, the white clouds, the oriental pearl TV tower, the Huangpu river, or other buildings. Then, the target segmented image is determined based on the target near-view point in the above step S103. For example, when the target near-view point in FIG. 2 falls on the oriental pearl TV tower, the segmented result image containing the oriental pearl TV tower is taken as the target segmented image. Thereafter, the target object contained in the target segmented image is determined based on the target segmented image. For example, the target object is the oriental pearl TV tower. FIG. 3 shows the effect after segmentation when the oriental pearl TV tower is used as the target object.

The present disclosure also provides a vehicle, which may include: a vehicle body, a target vehicle window, a target acquisition device, and a processing device. The target vehicle window may display an image and have a touch layer, and may obtain a tap position on the target vehicle window. The target acquisition device is configured to collect the head target position of the target user. The processing device is described with reference to FIG. 5. The processing device 1000 may include a tap position acquisition module 1001, an initial landing position determination module 1002, a target near-view point determination module 1003, a target object determination module 1004, and a display module 1005. The tap position acquisition module 1001 is configured to obtain the tap position of the target user on the target vehicle window, and the target vehicle window may display an image. The initial landing position determination module 1002 is configured to determine the initial landing position, in the outside-vehicle scene, for the line connecting the tap position and the head target position of the target user. The target near-view point determination module 1003 is configured to determine the target near-view point that meets a predefined positional relationship with the initial landing position when the initial landing position is a far-view landing position. The target object determination module 1004 is configured to determine the target object from the outside-vehicle scene based on the target near-view point. The display module 1005 is configured to display the target information of the target object on the target vehicle window.

It should be noted that the various processing modules of the processing device 1000 correspond to the processing methods described in the above method embodiments, which will not be described one by one here.

For the vehicle described in the disclosure, because the vehicle is equipped with the disclosed processing method, the vehicle may improve the user's tap accuracy rate for target objects in the 3D scene outside the window of the vehicle through the transparent window, thereby improving the user experience of the vehicle.

FIG. 5 shows a schematic structural diagram of a processing device reflecting a hardware implementation of a processing system. The processing device may include corresponding modules for executing each or several steps in the above flowchart. Therefore, each step or several steps in the above flowchart may be executed by a corresponding module, and the device may include one or more of these modules. The modules may be one or more hardware modules specifically configured to execute the corresponding steps, or may be implemented by a processor configured to execute the corresponding steps, or may be stored in a computer-readable medium for implementation by a processor, or implemented through certain combinations thereof.

The hardware structure may be implemented using a bus architecture. The bus architecture may include any number of interconnecting buses and bridges, depending on the specific application and overall design constraints of the hardware. Bus 1100 connects various circuits, including one or more processors 1200, memory 1300, and/or hardware modules. Bus 1100 may also connect various other circuits 1400, such as peripherals, voltage regulators, power management circuits, external antennas, etc.

Bus 1100 may be an industry standard architecture (ISA) bus, a peripheral component interconnect (PCI) bus, or an extended industry standard component architecture (EISA) bus. Buses may be classified as address buses, data buses, control buses, and the like. For ease of illustration, FIG. 5 shows only one connecting line, but this does not imply that there is only one bus or only one type of bus.

The processor 1200 may be a general-purpose processor, a digital signal processor, an application-specific integrated circuit (ASIC), a programmable logic device (PLD), or any combination thereof. The PLD may be a complex programmable logic device (CPLD), a field-programmable gate array (FPGA), a generic array logic (GAL), or any combination thereof. The general-purpose processor may be a microprocessor or any conventional processor.

Any process or method description in the flowchart or otherwise described herein may be understood to represent a module, fragment, or portion of code, including one or more executable instructions for implementing the steps of a specific logical function or process. The scope of the preferred embodiments of the present disclosure includes alternative implementations in which the functions may be performed in a substantially simultaneous manner or in a reverse order according to the functions involved, as will be understood by those skilled in the art to which the embodiments of the present disclosure pertain. The processor performs the various methods and processes described above. For example, the method embodiments in the present disclosure may be implemented as a software program that is tangibly contained in a machine-readable medium, such as a memory. In some embodiments, part or all of the software program may be loaded and/or installed via a memory and/or a communication interface. When the software program is loaded into the memory and executed by the processor, one or more steps in the methods described above may be performed. Alternatively, in other embodiments, the processor may be configured to perform one of the above methods in any other appropriate manner (e.g., by means of firmware).

The logic and/or steps represented in the flowchart or otherwise described herein may be embodied in any readable storage medium for use by, or in conjunction with, an instruction execution system, apparatus, or device (such as a computer-based system, a system including a processor, or other system that may fetch and execute instructions from an instruction execution system, apparatus, or device).

For the purposes of this specification, a “readable storage medium” may be any device that may contain, store, communicate, propagate, or transmit a program for use with or in conjunction with an instruction execution system, device, or apparatus. More specific examples (a non-exhaustive list) of readable storage media include the following: an electrical connection having one or more wires (electronic device), a portable computer disk cartridge (magnetic device), a random access memory (RAM), a read-only memory (ROM), an erasable and editable read-only memory (EPROM or flash memory), a fiber optic device, and a portable read-only memory (e.g., CD ROM). In addition, the readable storage medium may even be paper or other suitable medium on which the program may be printed, since the program may be obtained electronically, for example, by optically scanning the paper or other medium and then editing, interpreting or processing it in other suitable ways as necessary, and then storing it in a memory.

It is to be noted that various parts of the present disclosure may be implemented using hardware, software, or a combination thereof. In the above-described embodiments, multiple steps or methods may be implemented using software stored in a memory and executed by a suitable instruction execution system. For example, if implemented using hardware, as in other embodiments, any one of the following technologies known in the art or a combination thereof may be used to implement the hardware: a discrete logic circuit having a logic gate circuit for implementing a logic function on a data signal, an application-specific integrated circuit having a suitable combination of logic gate circuits, a programmable gate array (PGA), an FPGA, etc.

Those skilled in the art will understand that all or part of the steps of the above-described method embodiments may be accomplished by instructing related hardware through a program, and the program may be stored in a readable storage medium. When the program is executed, one or a combination of the steps of the method embodiments may be implemented.

In addition, the functional units in the various embodiments of the present disclosure may be integrated into a single processing module, each unit may exist physically separately, or two or more units may be integrated into a single module. The aforementioned integrated modules may be implemented in the form of hardware or software functional modules. If the integrated modules are implemented in the form of software functional modules and sold or used as independent products, they may also be stored in a readable storage medium. The storage medium may be a read-only memory, a magnetic disk, or an optical disk, etc.

In the description of this specification, the description with reference to the terms “one embodiment/method”, “some embodiments/methods”, “example”, “specific example”, or “some examples” means that the specific features, structures, materials or characteristics described in conjunction with the embodiment/method or example are included in at least one embodiment/method or example of the present disclosure. In this specification, the schematic representations of the above terms are not necessarily the same embodiment/method or example. Moreover, the specific features, structures, materials, or characteristics described may be combined in a suitable manner in any one or more embodiments/methods or examples. In addition, those skilled in the art may combine the different embodiments/methods or examples described in this specification and the features of the different embodiments/methods or examples, unless they are mutually inconsistent.

Furthermore, the terms “first” and “second” are used for descriptive purposes only and should not be construed as indicating or implying relative importance or implicitly specifying the number of the technical features being referred to. Thus, a feature defined as “first” or “second” may explicitly or implicitly include at least one of such features. Throughout the description of the disclosure, “plurality” means at least two, for example, two, three, etc., unless otherwise specifically defined.

Those skilled in the art will appreciate that the above embodiments are merely intended to clearly illustrate the present disclosure and are not intended to limit the scope of the present disclosure. Other changes or modifications may be made based on the above disclosure, and such changes or modifications are still within the scope of the present disclosure.

What is claimed is:

1. A processing method, comprising:
obtaining a tap position of a target user on a target vehicle window, the target vehicle window being capable of displaying an image;
determining an initial landing position, in an outside-vehicle scene, for a line connecting the tap position and a head target position of the target user;
when the initial landing position is a far-view landing position, determining a target near-view point that satisfies a predefined positional relationship with the initial landing position;
determining a target object from the outside-vehicle scene based on the target near-view point; and
displaying target information of the target object on the target vehicle window.

2. The method according to claim 1, wherein determining the initial landing position as the far-view landing position comprises:
obtaining a two-dimensional image corresponding to the outside-vehicle scene;
determining a near-view area and a far-view area of the two-dimensional image;
mapping the initial landing position into the two-dimensional image to obtain a mapping position; and
when the mapping position is within the far-view area, determining the initial landing position as the far-view landing position.

3. The method according to claim 1, wherein determining the initial landing position as the far-view landing position comprises:
determining a target value for the initial landing position in a first dimension, wherein the first dimension matches a normal direction of the target vehicle window; and
determining the initial landing position as the far-view landing position when the target value is greater than a predefined threshold.

4. The method according to claim 1, wherein determining the target near-view point that satisfies the predefined positional relationship with the initial landing position comprises:
searching along a first direction and a second direction to determine a plurality of first points that satisfy the predefined positional relationship with the initial landing position; and
determining a near-view point among the plurality of first points as the target near-view point.

5. The method according to claim 1, wherein satisfying the predefined positional relationship comprises that a distance corresponding to the initial landing position is less than a distance threshold, and wherein the method further comprises:
obtaining a target distance between the head target position of the target user and the target vehicle window; and
determining the distance threshold based on the target distance.

6. The method according to claim 1, wherein determining the target near-view point that satisfies the predefined positional relationship with the initial landing position comprises:
determining a mapping position corresponding to the initial landing position in a two-dimensional image, wherein the two-dimensional image is an image corresponding to the outside-vehicle scene, and the two-dimensional image is segmented into a near-view area and a far-view area; and
determining the target near-view point from the two-dimensional image according to the mapping position, wherein a distance between the target near-view point and the mapping position is less than a distance threshold.

7. The method according to claim 1, wherein determining the target near-view point that satisfies the predefined positional relationship with the initial landing position comprises:
determining the target near-view point from the outside-vehicle scene, wherein a distance between the target near-view point and the initial landing position in a second dimension is less than a distance threshold, wherein the second dimension matches a cross-section of the target vehicle window.

8. The method according to claim 1, wherein determining the target object from the outside-vehicle scene based on the target near-view point comprises:
inputting the target near-view point and a two-dimensional image corresponding to the outside-vehicle scene into a target model;
receiving a target segmented image corresponding to an individual object, segmented from the two-dimensional image by the target model, based on the target near-view point; and
determining the target object based on the target segmented image.

9. The method according to claim 1, wherein determining the target object from the outside-vehicle scene based on the target near-view point comprises:
obtaining a two-dimensional image corresponding to the outside-vehicle scene, the two-dimensional image being segmented into a plurality of segmented images corresponding to individual objects;
determining a target segmented image from the plurality of segmented images based on the target near-view point; and
determining the target object based on the target segmented image.

10. A vehicle, comprising:
a vehicle body;
a target vehicle window, capable of displaying an image and having a touch layer, and capable of acquiring a tap position on the target vehicle window;
a target acquisition device, configured to acquire a head target position of a target user; and
a processing device, including a memory and one or more processors, wherein the memory stores a computer program executable by the one or more processors, and when executing the computer program, the one or more processors are configured to perform:
obtaining the tap position of the target user on the target vehicle window,
determining an initial landing position, in an outside-vehicle scene, for a line connecting the tap position and the head target position of the target user,
when the initial landing position is a far-view landing position, determining a target near-view point that satisfies a predefined positional relationship with the initial landing position,
determining a target object from the outside-vehicle scene based on the target near-view point, and
displaying target information of the target object on the target vehicle window.

11. The vehicle according to claim 10, wherein the one or more processors are further configured to perform:
obtaining a two-dimensional image corresponding to the outside-vehicle scene;
determining a near-view area and a far-view area of the two-dimensional image;
mapping the initial landing position into the two-dimensional image to obtain a mapping position; and
when the mapping position is within the far-view area, determining the initial landing position as the far-view landing position.

12. The vehicle according to claim 10, wherein the one or more processors are further configured to perform:
determining a target value for the initial landing position in a first dimension, wherein the first dimension matches a normal direction of the target vehicle window; and
determining the initial landing position as the far-view landing position when the target value is greater than a predefined threshold.

13. The vehicle according to claim 10, wherein the one or more processors are further configured to perform:
searching along a first direction and a second direction to determine a plurality of first points that satisfy the predefined positional relationship with the initial landing position; and
determining a near-view point among the plurality of first points as the target near-view point.

14. The vehicle according to claim 10, wherein satisfying the predefined positional relationship comprises that a distance corresponding to the initial landing position is less than a distance threshold, and wherein the one or more processors are further configured to perform:
obtaining a target distance between the head target position of the target user and the target vehicle window; and
determining the distance threshold based on the target distance.

15. The vehicle according to claim 10, wherein the one or more processors are further configured to perform:
determining a mapping position corresponding to the initial landing position in a two-dimensional image, wherein the two-dimensional image is an image corresponding to the outside-vehicle scene, and the two-dimensional image is segmented into a near-view area and a far-view area; and
determining the target near-view point from the two-dimensional image according to the mapping position, wherein a distance between the target near-view point and the mapping position is less than a distance threshold.

16. The vehicle according to claim 10, wherein the one or more processors are further configured to perform:
determining the target near-view point from the outside-vehicle scene, wherein a distance between the target near-view point and the initial landing position in a second dimension is less than a distance threshold, wherein the second dimension matches a cross-section of the target vehicle window.

17. The vehicle according to claim 10, wherein the one or more processors are further configured to perform:
inputting the target near-view point and a two-dimensional image corresponding to the outside-vehicle scene into a target model;
receiving a target segmented image corresponding to an individual object, segmented from the two-dimensional image by the target model, based on the target near-view point; and
determining the target object based on the target segmented image.

18. The vehicle according to claim 10, wherein the one or more processors are further configured to perform:
obtaining a two-dimensional image corresponding to the outside-vehicle scene, the two-dimensional image being segmented into a plurality of segmented images corresponding to individual objects;
determining a target segmented image from the plurality of segmented images based on the target near-view point; and
determining the target object based on the target segmented image.
